(19) United States
(12) Patent Application Publication
(10) Pub. No.: US 2011/0222921 A1
(43) Pub. Date: Sep. 15, 2011

(54) FIXING DEVICE AND IMAGE FORMING APPARATUS

(76) Inventors: Masanori MURAKAMI, Tokyo (JP); Hiroshi Funabiki, Uenohara-shi (JP); Jinju Okuno, Tokyo (JP); Koji Yamamoto, Toyokawa-shi (JP)

(21) Appl. No.: 13/044,350

(22) Filed: Mar. 9, 2011

(30) Foreign Application Priority Data
Mar. 12, 2010 (JP) JP2010-055576

(51) Int. Cl. G03G 15/20

(52) U.S. Cl. 399/323

(57) ABSTRACT

A fixing device for fixing a toner image onto a recording sheet by applying a pressure and a heat during conveying the recording sheet at a nip portion, includes: a fixing member including a heating section; a pressure-applying member forming the nip portion with the fixing member; an air blow duct provided with an air discharge opening which opens toward a vicinity of a recording sheet outlet of the nip portion; and an air blowing section which blows air toward the vicinity, wherein fixing device further includes an air drain path provided with an air suction opening at the vicinity of the outlet of the recording sheet and suctioning the air blown toward the vicinity of the outlet of the recording sheet thereby draining the air. The air drain path is separated from a sheet conveyance path by a separation wall member and formed above the sheet conveyance path.

### CROSS REFERENCE TO RELATED APPLICATION

This application is based on Japanese Patent Application No. 2010-055576 filed on Mar. 12, 2010 at the Japanese Patent Office, the entire content of which is hereby incorporated by reference.

### FIELD OF THE INVENTION

The present invention relates to a fixing device that fixes a toner image on a sheet in a nip portion formed by a fixing member and a pressure-applying member.

### DESCRIPTION OF RELATED ART

In an image forming apparatus using an electrophotographic process such as a copying machine, a printer, a facsimile machine and a multifunctional peripheral equipped with various functions of the aforesaid items, a latent image corresponding to a document is formed, then, the latent image is visualized by applying toner to the latent image, and the developed toner image is transferred onto a recording sheet, after that, the toner image transferred onto the recording sheet is fixed, and the sheet is ejected.

As a fixing device that fixes a toner image in the aforesaid way, there is a fixing device of a heat roller fixing type wherein a recording sheet onto which a toner image has been transferred is heated and is given a pressure in a nip portion that is formed by a fixing roller (fixing member) having therein a built-in halogen heater and by a pressure-applying roller that applies pressure to the fixing roller, while being sandwiched and conveyed, and the fixing device of this type is widely used because of its simple structure.

Further, there is a fixing device of a belt-fixing type wherein a fixing belt (fixing member) in an endless form is trained about a heating roller having therein a built-in halogen heater and about a fixing roller, and a pressure-applying roller that applies a pressure to the fixing roller through the fixing belt is provided, and a recording sheet onto which a toner image has been transferred is heated and pressed while being sandwiched and conveyed in a nip portion that is formed by the fixing belt and the pressure-applying roller, and the fixing device of this type has an advantage that warming-up time is short because thermal capacity of the fixing belt is small, resulting in energy conservation.

In this case, since toner of the toner image on the recording sheet is heated when it passes through the nip portion, the toner has adhesion, and the recording sheet that has passed through the nip portion may stick to surfaces of the fixing roller and the fixing belt to wind itself around the fixing roller and the fixing belt, without being separated to cause a jam. With respect to a recording sheet, in particular, when a sheet (thin paper) having small basis weight, in further particular when the sheet is a coated paper for printing having small basis weight is used, releasing efficiency is reduced.

On the other hand, when a fixing roller is made to be greater for securing a sufficiently long nip width, to meet speeding up of an image forming apparatus, the roller curvature at the fixing nip outlet is reduced, which results in reducing the releasing efficiency.

For the purpose of obtaining easier separation of a recording sheet from the fixing member, there are taken various measures including using heat-resistance resins having high releasability for an outer layers of a fixing member, coating release agents such as silicon oil and making toner to contain wax that is dissolved by heating and functions as release agent. However, primary factors to lower releasing efficiency such as image forming on the aforesaid coated paper and adhesive force caused by an increase of toner amount caused by overlapping of plural colors which form color images, have been increased, which makes a separation device for separating a sheet to be indispensable.

As a separation device, there is a method wherein a releasing claw that is coated with fluorocarbon resin having excellent releasability is provided on the sheet outlet side for the recording sheet for the nip portion, and a tip portion of the releasing claw is caused to touch an outer surface of the fixing roller or the fixing belt, so that the recording sheet is released from the fixing roller.

However, the aforesaid method has a problem that scratches are caused on an outer layer formed by fluorocarbon resin that covers a surface of the fixing roller, because the tip portion of the releasing claw is in contact with an outer layer of a surface if fixing roller, and the scratches are transferred also onto an image. In the case of color images, a surface of the fixing roller, in particular, these scratches are in a tendency to appear remarkably, because glossy images are required.

To deal with the problem of this kind, there has been developed a technology to cause a recording sheet to be released from the fixing roller by blowing air against the outlet side of the nip portion.

When air is blown so that the fixed recording sheet will not stick to the fixing roller or others, and the recording sheet is released from the fixing roller, the effect is influenced by the area of the portion on which air is blown. If no toner image is formed close to the leading edge of the recording sheet and there is a wide area free from adhesive force, the leading edge of the recording sheet is released by the toughness and weight of the recording sheet, and air is received by the released area. This provides a greater releasing force. However, when a toner image has been formed up to the leading edge of the recording sheet, the recording sheet is conveyed in the direction tangential to the outer periphery of the fixing roller and others. This minimizes the clearance between the leading edge of the recording sheet and the outer periphery of the fixing roller and others. For example, when the outer diameter of the fixing roller is 90 mm and the margin of the leading edge of the recording sheet is 3 mm, the clearance is only 0.1 mm. To blow air into this clearance and lift the leading edge of the recording sheet, it is necessary to blow air at a high velocity, namely, high pressure air to the nip section. To achieve this, it is preferred to use the high-pressure compressed air produced from a compressor.

As an example of the foregoing, there is known a sheet releasing device that is corresponded to a high speed copying machine by storing compressed air generated by a compressor in two air boxes, and by jetting the compressed air through alternately opening and closing of two electromagnetic valves connected to the air boxes (for example, Unexamined Japanese Patent Application Publication No. S60-256180).

Further, there is known a sheet releasing device that can release a sheet without fail through a method wherein plural air puffer manifolds that blow air in the circumferential direction of a soft roller are arranged, and when the first air blowing fails to release a sheet, the second air blowing releases the sheet (for example, see Unexamined Japanese Patent Application Publication No. S61-62087).

In addition to the foregoing, there is known a fixing device wherein compressed air generated by a compressor is discharged through two electromagnetic valves, and when a leading edge of a recording sheet passes through a nip portion, high pressure compressed air is jetted, and after that, low pressure compressed air is jetted (see Unexamined Japanese Patent Application Publication No. 2007-86132).

A phenomenon that the recording sheet that has passed through the nip portion is not released and sticks to surfaces of the fixing roller and the fixing belt to wind itself around the surfaces of them takes place on the leading edge portion of the recording sheet and also takes place on other portions after the leading edge portion. Further, even when the leading edge of the recording sheet is drawn out by a sheet-ejection roller, uneven separation is caused on the winded portion. Therefore, in the case of a structure to release a recording sheet by a fixing roller or the like by blowing air against the side of the outlet of the nip portion, it is necessary to blow air continuously.

However, the air blown continuously reflects at the nip portion and causes turbulent airflow, such as whirling after the sheet is released from the fixing milers and so on. The turbulent airflow may cause the sheet to flap and the conveyance of the sheet to be out of order. In particular, the sheet which is low in stiffness, thin and has small basis weight is vulnerable to such turbulent airflow, and becomes a cause of conveyance trouble such as paper jam. Further, air which becomes heated by touching the surface of the heating member appropriately disperses inside of the image forming apparatus, thereby cause an increase of the temperature of the developing agents, a cleaning trouble of the photoreceptor and so on.

In Unexamined Japanese Patent Application Publications No. S60-256180, No. S61-62087, and No. 2007-86132, no countermeasures to the above said problems are applied.

To counter the problem, an fixing device which comprises a compressed air jetting out member which jets out compressed air along the circumference surface toward the both ends of the fixing member to separate the sheet is proposed (for example, see Unexamined Japanese Patent Application Publication No. 2007-206153).

In Unexamined Japanese Application Publication No. 2007-206153, the conveyance of the sheet released from the fixing member is stabilized through inhibiting the turbulence of the jetted airflow by turning the direction of the jetted compressed toward both edge directions from the center of the advancing sheet and thorough inhibiting the retaining of the jetted air near the fixing member.

However, when blowing compressed air continuously, compressed air that is nearly equal to 0.01 m³/s is needed. For generating compressed air in this air quantity, a high-power compressor of 5-10 kw is needed, because a lot of energy is required for generating compressed air, and there is a fear that a large-sized apparatus in a size of about 1 m³, composed of a compressor and an air tank is needed.

The same argument that an apparatus is feared to be large-sized can be applied to Unexamined Japanese Patent Application Publications No. S60-256180, No. S61-62087, and No. 2007-86132.

Compared to compressors, air blowers (after here, called fans), such as centrifugal fan and axial fan, for example, are capable of achieving high air quantity although they are compact and have a low power consumption. However their upper limit of pressure is low (several hundreds of Pa), could not acquire enough separability for the margin of the leading edge of several mm, when a coated paper having a high surface flatness, a low rigidness and a small basis weight is a is used,

However, after the leading edge of the sheet is released, it is possible even for the fans to release the sheet. Therefore, through combining the compressor and the fan, releasing the sheet can be achieved, by blowing air by a fan after releasing the edge of the sheet by blowing the compressed air for the releasing the edge of the sheet by a compressor. Further the compressor and the fan can be used concurrently to blow air. As explained above, the compressor can be small and have a low power, by combining the compressor and the fan.

When the sheet is released by a fan, as explained above, the air blown by the fan has a low pressure, it is preferred to blow air to fixing roller and so on in a direction perpendicular to a width direction of the sheet, in order that the releasing is achieved effectively.

However, when the air is continuously blown in the perpendicular direction, as explained above, the blown air reflects at the nip portion and causes the turbulent airflow such as whirling after the sheet is released from the fixing member and so on. The turbulent airflow may cause the sheet to flap, the conveyance of the sheet to be out of order. The flap becomes a cause of conveyance trouble such as paper jam.

The present invention has been accomplished in view of the aforesaid problems, and its object is to propose a fixing device with a structure to inhibit the flap of the sheet caused by the air blown to release the sheet from the fixing member and thereby achieve a stable conveyance of the sheet.

### SUMMARY OF THE INVENTION

To achieve at least one of the abovementioned objects, a fixing device reflecting one aspect of the present invention is characterized in that a fixing device fixing a toner image onto a recording sheet carrying the toner image thereon by applying a pressure and a heat during conveying the recording sheet in a nip portion, comprising: a fixing member including a heating section; a pressure-applying member, by touching the fixing member, forming the nip portion which sandwiches the sheet carrying the toner image; an air blow duct provided with an air discharge opening which opens toward a vicinity of an outlet of the recording sheet of the nip portion; and an air blowing section which blows air toward the vicinity of the outlet of the recording sheet through the air blow duct, wherein fixing device further comprises an air drain path provided with an air suction opening at the vicinity of the outlet of the recording sheet and suctioning the air blown toward the vicinity of the outlet of the recording sheet from the air suction opening thereby draining the air, the air drain path separated from a sheet conveyance path by a separation wall member and formed above the sheet conveyance path.

### BRIEF DESCRIPTION OF THE DRAWINGS

FIG. 1 is a schematic diagram representing an example of an image forming apparatus relating to the present invention.

FIG. 2 is a cross-sectional view representing an example of a fixing device relating to the present invention.

FIG. 3 is a diagram representing Embodiment 1.

FIG. 4 is an enlarged diagram near an air discharge opening.

FIG. 5 is a bottom view of Embodiment 1.

FIG. 6 is a perspective view representing an example of air nozzles and relating constitutions.

FIG. 7 is a diagram representing results of experiments using present invention and conventional example.

FIG. 8 is a diagram representing Embodiment 2.

FIG. 9 is a bottom view of Embodiment 2.

FIG. 10 is a diagram representing Embodiment 3.

FIG. 11 is a diagram representing Embodiment 4.

FIG. 12 is a diagram representing Embodiment 5.

FIG. 13 is a top view of Embodiment 5.

FIG. 14 is a diagram representing an approximate size of Embodiment 5.

FIG. 15 is a top view of Embodiment 6.

FIG. 16 is a diagram representing Embodiment 7.

FIG. 17 is a diagram representing Embodiment 8.

FIG. 18 is a top view of Embodiment 8.

FIG. 19 is a diagram representing Embodiment 9.

FIG. 20 is a top view of Embodiment 9.

### DETAILED DESCRIPTION OF THE PREFERRED EMBODIMENT

Embodiments concerning the present invention will be explained as follows, referring to drawings.

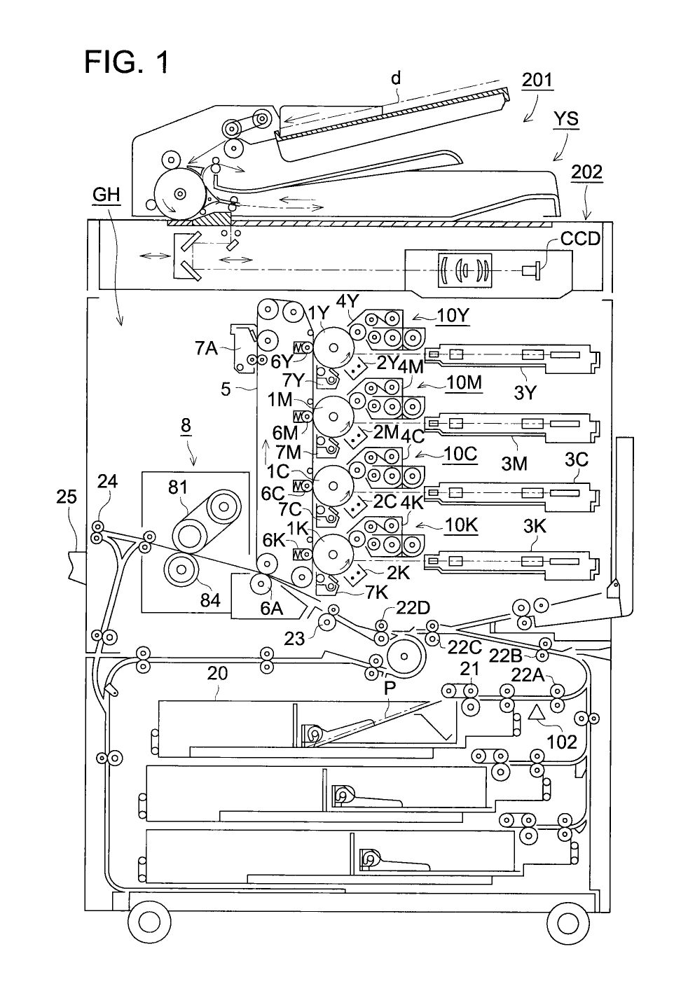

First, an example of an image forming apparatus that uses the present invention will be explained as the following, based on a schematic diagram in FIG. 1.

The present image forming apparatus is composed of an image forming apparatus main body GH and an image reading device YS. The image forming apparatus main body GH is an object that is called a color image forming apparatus of a tandem type, and it is composed of plural sets of image forming sections 10Y, 10M, 10C and 10K, belt-shaped intermediate transfer belt 5, sheet feeding conveyance device and fixing device 8.

On the upper portion of the image forming apparatus main body GH, there is arranged the image reading device YS that is composed of an automatic document feeder 201 and of a document image scanning exposure device 202. Document d placed on a document platen of the automatic document feeder 201 is conveyed by a conveyance device, thereby, images on one side or both sides of the document are given scanning exposure by an optical system of the document image scanning exposure device 502, to be read in line image sensor CCD.

Signals formed by the line image sensor CCD through photoelectric conversion undergo analog processing, A/D conversion, shading correction and image compression processing, in an image processing section, and are sent to exposure devices 3Y, 3M, 3C and 3K.

On image forming section 10Y that forms a yellow (Y) color image, there are arranged, on a circumference of photoconductor drum 1Y, charging device 2Y, exposure device 3Y, developing device 4Y and cleaning device 7Y. On image forming section 10M that forms a magenta (M) color image, there are arranged, on a circumference of photoconductor drum 1M, charging device 2M, exposure device 3M, developing device 4M and cleaning device 7M. On image forming section 10C that forms a cyan (C) color image, there are arranged, on a circumference of photoconductor drum 1C charging device 2C, exposure device 3C, developing device 4C and cleaning device 7C. On image forming section 10K that forms a black (K) color image, there are arranged charging device 2K that is on a circumference of photoconductor drum 1K, exposure device 3K, developing device 4K and cleaning device 7K. And, a latent image forming device is composed of a combinations including a combination of the charging device 2Y and the exposure device 3Y, a combination of the charging device 2M and the exposure device 3M, a combination of the charging device 2C and the exposure device 3C and of a combination of the charging device 2K and the exposure device 3K.

Incidentally, the developing devices 4Y, 4M, 4C and 4K involve respectively two component developer that contains small particle size toner in yellow (Y) and carrier, two component developer that contains small particle size toner in magenta (M) and carrier, two component developer that contains small particle size toner in cyan (C) and carrier, and two component developer that contains small particle size toner in black (K) and carrier. The toner is composed of pigments or dyes each serving as color couplers, waxes that assist toner to release from a fixing member after fixing and binder resins which holds the aforesaid items.

The intermediate transfer belt 5 is trained about a plurality of rollers, to be supported to be rotatable.

The fixing device 8 fixes a toner image on a recording sheet P by heating the toner image and by applying pressure to the toner image in a nip portion that is formed between the heated fixing belt 81 and a pressure-applying roller 83.

Thus, images in different respective colors formed respectively by image forming sections 10Y, 10M, 10C and 10K, are transferred onto rotating intermediate transfer belt 5 one after another by transfer devices 6Y, 6M, 6C and 6K (primary transfer), thereby, a toner image wherein color images are composed is formed. Recording sheet P loaded in sheet feed cassette 20 is fed by sheet feed device 21, and is conveyed to transfer device 6A through sheet feed rollers 22A, 22B, 22C, 22D and registration roller 23, so that a color image is transferred onto the recording sheet P (secondary transfer). The recording sheet P onto which the color image has been transferred undergoes heating and pressure-applying in fixing device 8, and a color toner image on the recording sheet P is fixed. After that, the recording sheet P is sandwiched by sheet ejection roller 24 to be placed on sheet ejection tray 25 that is located on the outer side of the apparatus.

On the other hand, after the color image has been transferred onto recording sheet P by transfer device 6A, residual toner on the intermediate transfer belt 5 is removed by cleaning device 7A from the intermediate transfer belt 5 from which the recording sheet P has been curvature-released.

Meanwhile, the foregoing has been for the image forming apparatus that forms a color image. However, the foregoing may also be for an image forming apparatus that forms a monochrome image, and the intermediate transfer belt may either be used or it may not be used.

Further fixing device 8 may be a heat roller fixing type using a roller provided with a fixing member and heating section.

Next, fixing device 8 relating to the present invention will be explained referring to the drawings.

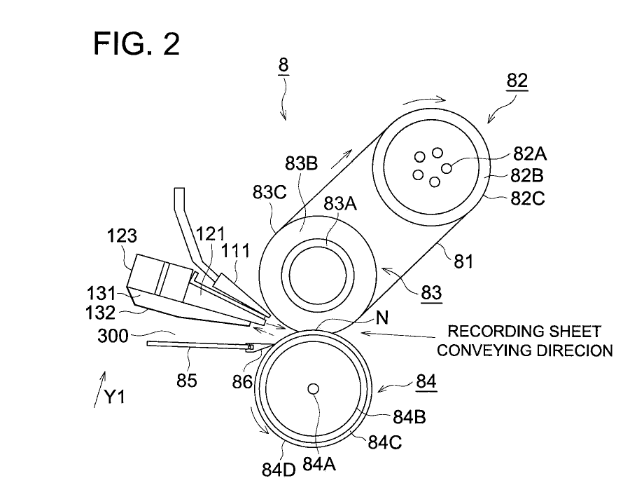

FIG. 2 is a cross-sectional view representing an example of a fixing device (belt type fixing device) relating to the present invention. The fixing device will be explained as follows based on an example of the case where the image formation on sheets P of A4 size is performed 100 sheets per minute.

Fixing belt 81 (fixing member) is formed to be in an endless form wherein, for example, 70 μm thick PI (polyimide) is used as a substrate, then, an outer circumferential surface of the substrate is covered by 200 μm-thick heat-resistant silicone rubber (hardness JIS-A150) as an elastic layer and is further covered by a tube of PFA (perfluoro alkoxy) that is 30 μm thick heat-resistance resin. Its size of the outside diameter is, for example, 168 mm. As another constitution, it is also possible to use a metallic substrate such as nickel electrocasting for a substrate, to use fluorine-containing rubber for an elastic layer and to use a fluorine-containing resin coated layer such as PFA and PTFE (polytetra-fluoro ethylene) for a surface releasing layer.

Heating roller 82 houses therein halogen heater 82A serving as a heating device that heats fixing belt 81, and an outer circumferential surface of 4 mm-thick cylindrical sleeve 82B made of aluminum, for example, is covered by resin layer 82c that is coated with 30 μm-thick PTFE. Its dimension of the outside diameter is, for example, 90 mm. Incidentally, the halogen heater 82A is composed of, for example, two 1200 W heaters, two 750 W heaters and one 500 W heater, and they are arranged so that heat generation distribution may vary in the axial direction to cope with different widths of recording sheet.

With respect to fixing roller 83, solid core 83A that is made of a metal such as iron is covered by 17 mm-thick heat-resistant silicone rubber (hardness RS-A10°) as elastic layer 83B and is further covered by resin layer 83C that is coated with 30 μm-thick PTFE representing low frictional and heat-resistant resin. Its dimension of the outside diameter is, for example, 90 mm.

Pressure-applying roller 84 (pressure-applying member) houses therein halogen heater 84A for the purpose of shortening a temperature-raising time immediately after power activation for an image output apparatus, then, an outer circumferential surface of 4 mm-thick cylindrical sleeve 84B that is made of aluminum is covered by 2 mm-thick heat-resistant silicone rubber (hardness JIS-A10°) as elastic layer 84C, and it is further covered by resin layer 84D of 30 μm-thick PFA tube. Its dimension of the outside diameter is 90 mm. Incidentally, wattage of the halogen heater 84A is, for example, 700 W.

In an unillustrated urging device, pressure-applying roller 84 presses fixing roller 83 through fixing belt 81.

In the aforesaid constitution, when the pressure-applying roller 84 is rotated counterclockwise by an unillustrated drive device, fixing belt 81 and heating roller 82 rotate clockwise, and fixing roller 83 rotates clockwise. Incidentally, the fixing roller 83 may also be driven. Further, the fixing belt 81 is heated by halogen heater 82A through heating roller 82 that comes in contact, and pressure-applying roller 84 is also heated by halogen heater 84A. Then, since the pressure-applying roller 84 is urged in the direction of fixing roller 83, recording sheet P which has been fed is heated and applied with pressure in nip portion N that is formed between fixing belt 81 that is trained about fixing roller 83 and between pressure-applying roller 84, thus, the toner image on recording sheet P is fixed.

Incidentally, fixing conditions, for example, are as follows.

Fixing belt tension: 250N

Fixing belt control temperature: 160-200° C.

Pressure-applying roller control temperature: 80-120° C.

Recording sheet conveyance speed: 500 mm/s

Further, as a heating device for heating fixing belt 81, any type of heating device can be used, and, for example, a heating element of an induction heating type employing a magnetizing coil can be used. Further, a position where a heating device is mounted is not always limited to be in the heating roller 82.

It is further possible to provide a tension roller that gives tension to the fixing belt 81 and to provide a skew-control roller that controls meandering of a belt.

In the fixing device 8 mentioned above, recording sheet P needs to be released surely from the fixing belt 81, because there is a fear of occurrence of a jam if recording sheet P that has undergone fixing sticks to the fixing belt 81 to twine the sheet around the fixing belt after the sheet is released from nip portion N.

Therefore, in the fixing device 8 relating to the present invention, a releasing device which blows air toward the outlet side of the nip portion N so as to release the sheet from the fixing belt 81.

Next, the releasing section will be explained.

### Embodiment 1

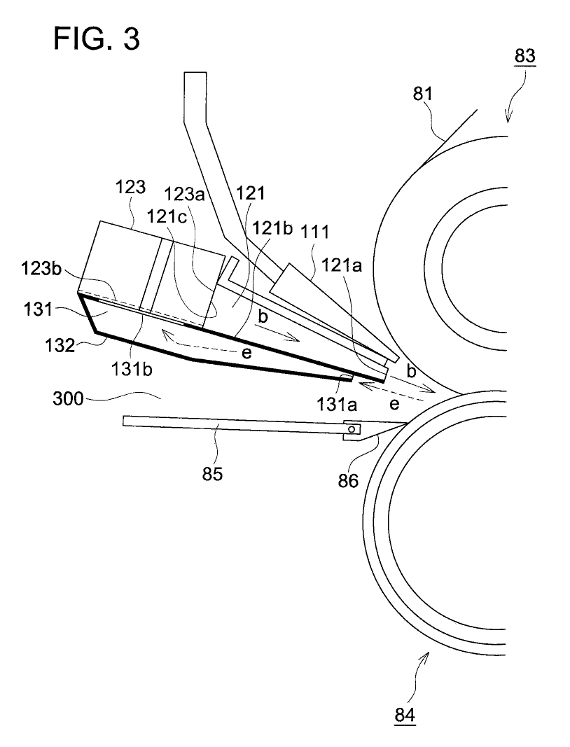

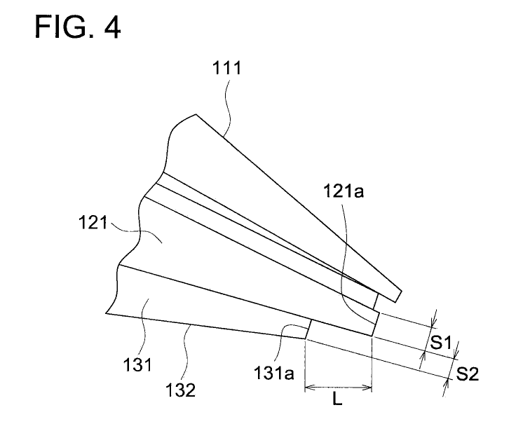

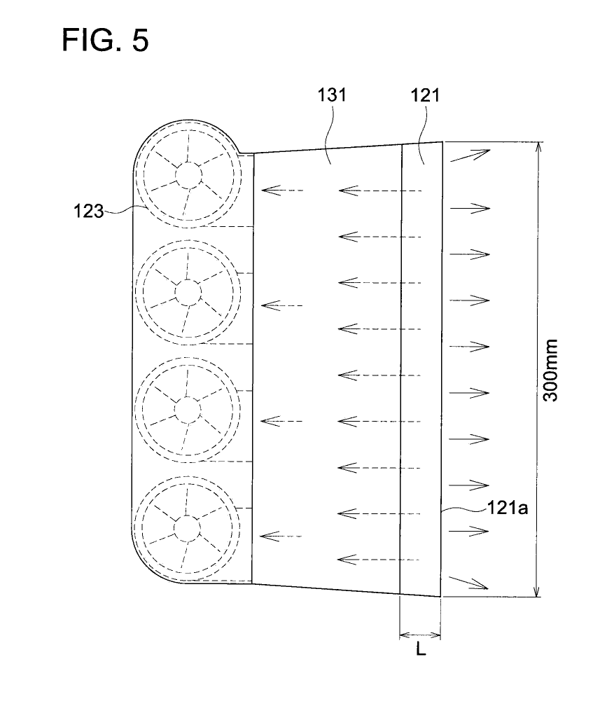

FIG. 3 is an enlarged diagram of the belt fixing device 8 shown in FIG. 2 near the releasing section and represents Embodiment 1. FIG. 4 is an enlarged diagram near the air discharge opening 121a. Further FIG. 5 is a bottom view viewed in a direction of arrow Y of FIG. 2. of Embodiment 1.

The releasing section is provided with air nozzle 111 (first air blowing section) and air blowing duct 121 (second air blowing section).

The first air nozzle 111 is a nozzle through which compressed air generated through compression by a compressor is blown out, and air is blown for a short period of time against the vicinity of the leading edge of recording sheet P immediately after passing through the nip portion, thus, the leading edge portion of recording sheet P is released from the fixing belt 81.

The air nozzle 111 is disposed such that the distance of the edge portion of the nozzle from the outlet of the nip portion is 25 mm and the extended line of the nozzle crosses at about 10 mm from the outlet of the nip portion on the outer circumference of the fixing belt 81 in the rotational direction. That is, the position of the air blown out from the nozzle 111 locates at 10 mm from the outlet of the nip portion on the outer circumference of the fixing belt 81 in the rotational direction.

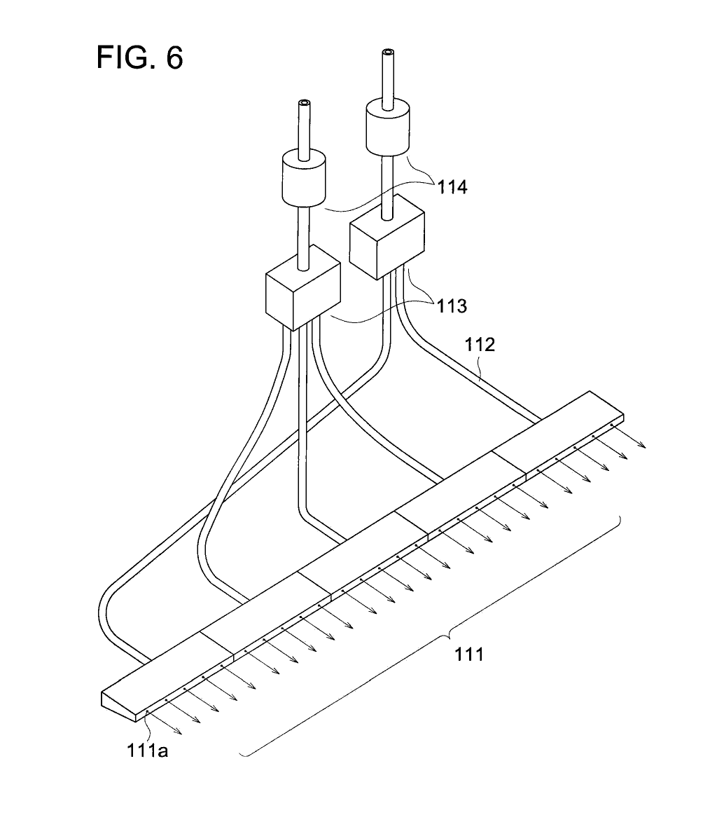

FIG. 6 is a perspective view representing the air nozzles 111 and relating constitutions. In FIG. 6, five air nozzles 111 are disposed in a width direction of recording sheet P (longitudinal direction of the nip portion N), and each air nozzle 111 is provided with twenty six nozzle holes 111a each having an opening diameter of 0.8 mm arranged with a pitch of 2.5 mm. Therefore total number of the nozzle holes 111a of five air nozzle is one hundred thirty.

Five air nozzles 111 are connect to two plumbing sections 113 with five pipes wherein each of the five air nozzles 111 is connected to each of the five pipes, and each of the two plumbing section 113 is connected to electromagnetic valve 114. Although the drawing does not show after the electromagnetic valves 114, the electromagnetic valves 114 are connected to air tank 204 and the air tank is connected to a compressor.

In this case, the electromagnetic valves 114 are of a direct-acting type, and capacity of the electromagnetic valve 114 is 0.002 m³/s (100 kPa) and a response speed thereof is 20 ms. A capacity of the air tank 204 is 0.05 m³. The compressor is of a reciprocating-oil-free type, and its electric power is 0.75 kw, static pressure is 0.8 MPa and air blow quantity is 0.00125 m³/s.

An air blow duct 121 is provided with an air discharge opening 121a which opens facing to sheet outlet of the nip portion N and an opening section 121c which is connected to a blown out opening 123a of a fan 123 as an air blowing section.

The air blow duct 121 is disposed such that the air discharge opening 121a is located with a distance of 25 mm from the outlet of the nip portion and an air blown position is about 10 mm from the outlet of the nip portion on the outer circumference of the fixing belt 81 in the rotational direction.

The fan 123 blows air continuously toward near the outlet of the nip portion N through the air blow duct 121 from the air discharge opening 121a so as to blow air to recording sheet P whose leading edge is released and prevent recording sheet P from adhering to the fixing belt 81.

The fan 123 is preferred to be a centrifugal fan wherein the direction of inletting air and the direction of discharging air are perpendicular, for example, such as a sirocco fan, in respects to small size, light weight, low cost, and so on, but is not limited to this.

The fan 123 is, for example, a sirocco fan with a size of 97 mm×33 mm whose electric power is 39 W and whose static pressure is 1280 Pa.

In Embodiment 1(FIGS. 1 through 5), four fans 123 are in use. The fans 123 are disposed such that the air inlet openings 123b face downward. The air discharge opening 121a of the air blow duct 121 has a width of 300 mm in the width direction of recording sheet P and a height of 1.6 mm in a height direction of a cross section (S1 of FIG. 4). Further the four fans have four opening sections 121c to each of which an air blow out opening of each of the fans is connected.

In the aforesaid explanation, the blow duct 121 is an integrated type in which four fans 123 are connected with one blow duct 121, however the blow duct 121 may be a separate type which is composed of four blow ducts in each of which one fan 123 is connected with one blow duct 121. In the separate type, four blow ducts 121 each of which is provided with an air discharge opening 121a having a width of 75 mm in the width direction of recording sheet P and a height of 1.6 mm in a thickness direction of recording sheet P are arranged continuously in the width direction of recording sheet P.

In the image forming operation, simultaneously with feeding out of recording sheet P from the registration roller 23 (refer to FIG. 1), electricity is supplied to the fans 123 and air is blown from the blow duct 121 to supplement the releasing. In the vicinity of the outlet of the nip portion N, an air flow with a speed of about 20 m/s from the image forming surface side to the no-image forming surface side is formed.

Compressed air is supplied to the air nozzle 111 from the compressor vie through electromagnetic valve 114. The electromagnetic valve 114 is closed in a normal state. The electromagnetic valve 114 is changed to be opened by sending a signal for opening in accordance with coming out of the leading edge of recording sheet P from the nip portion N. The changing timing is calculated by a sheet supply signal of recording sheet P before the secondary transference (sheet supply signal to registration roller 23). A sensor for detecting leading edge of sheet may be provided before the nip portion N.

The air flow reaches to the maximum flow rate when the leading edge protrudes about 10 mm from the nip portion because the valve 114 becomes the open state in about 20 ms. In the present embodiment, air of two to three times of the pressure required for the releasing is supplied, therefore the releasing of recording sheet P starts before the air flow blown from air nozzle 111 reaches to the maximum flow rate, that is, before the wound amount from the nip portion N reaches to 10 mm.

By performing experiments for the present embodiment, it has been confirmed that even thin coated papers for printing having small basis weight about 80 g/m² and having a solid image of a maximum carrying toner amount can be continuously released under the air blast of about 20 m/s if the releasing operation is performed when the leading edge protrudes from 5 to 10 mm from the nip portion.

A signal for closing is inputted to the electromagnetic valve 114 after 50 ms has passed since the signal for opening.

As explained above, recording sheet P can be securely released from fixing belt 81 even when compressed air is not blown from the first air nozzle 111, because the sheet is in a state of receiving blown air blown from the fans 123, because the leading edge is released more than 10 mm and a releasing force of recording sheet P with countering a sticking force of toner is applied in a direction toward non image surface side.

In experiments, it has been confirmed that when recording sheet P is released after its leading edge section winds the fixing belt 81 10 mm or more, the larger the winding amount is, the more image unevenness considered to be caused by changes of releasing state is generated, and, the more, image appearance quality is lowered, accordingly. As explained above, the unevenness is not generated because the releasing starts before the winding amount reaches this value.

The recording sheet P separated from the fixing belt 81 is conveyed by the pressure-applying roller 84, while recording sheet P is pressed by air flow toward the pressure-applying roller 84. Further, recording sheet P is released by the separation claw 86 whose width at front edge section is about 10 mm, in contact with the pressure-applying roller 84 at a pressure of about 1 mN and is guided by sheet ejection guide plate 85 to be conveyed. The separation claw 86 is made of heat-resistant resin coated with fluorine-containing resin. The contact pressure of the separation claw 86 is determined to be an extent such that the pressure-applying roller 84 is not hurted, depending on the relation between the width and the material of the claw and the surface material of the pressure-applying roller 84.

The sheet ejection guide plate 85 is configured by being provided with ribs parallel to the recording sheet conveying direction or a plurality of small rollers and thereby prevents recording sheet P ejected from sticking to the ejection guide plate 85 and causing an ejection error. The temperature of the pressure-applying roller 84 is maintained to be a temperature in which the toner is not melted (90-110° C. in the present embodiment), so image hurt and so on caused by the separation claw 86 does not happen even if the image is formed at the side to the pressure-applying roller 84. Further, for the purpose of keeping the pressure-applying roller 84 to be at a low temperature, an amount of heat transmission from fixing belt 81 to pressure-applying roller 84 is controlled by making a distance between transfer device and fixing device to be a length that is the maximum of the length of recording sheet P or more, and shortening a space between sheets in the aforesaid distance. It is further possible to cool an inner circumference and an outer circumference of the pressure-applying roller 84 by a fan. The separation claw 86 can be a separation claw which is used in a conventional fixing device.

As explained above, in order that releasing is effective in the case where air is blown out for releasing recording sheet P from the fans 123 after separating the leading edge of recording sheet P, the direction of air blown from the fans 123 is preferred to be perpendicular to the width direction of the fixing belt 81 as air blown out from fans 123 is in a low pressure

When the air is continuously blown in the perpendicular direction from the fans 123, as explained above, the blown air reflects at the nip portion and causes the turbulent airflow such as whirling after the sheet is released from the fixing belt 81. The turbulent airflow may cause the sheet to flap, the conveyance of the sheet to be out of order. The flap becomes a cause of conveyance trouble such as paper jam.

On the other hand, the fixing device 8 of the present invention is provided with an air draining path formed above the conveyance path 300 of recording sheet P by being separated from the conveyance path by a separation plate 132. The sheet draining path is formed of an air drain duct 131 provided with an air inlet opening 131a facing toward near the outlet of the nip portion N and an air draining opening 131b. The separating plate 132 constitutes a lower member which is a part of member constitutes the air drain duct 131.

The air inlet opening 131a has an opening of 300 mm in the direction of the width direction of recording sheet P approximately equivalent to the opening of the air discharge opening 121a of the air blowing duct 121

The air drain duct 131 is arranged next to the air blowing duct 121 and at the side of the conveyance path 300. Further members constitute the air drain duct 131 may be exclusive for the air drain duct 131 and a part of the members may be common with the air blowing duct 121. For example, in the embodiment shown in FIG. 3, the bottom surface plate 121b constituting the bottom surface of the air blowing duct 121 is commonly used as the top surface plate constituting the top surface of the air drain duct 131.

The air inlet openings 123b of the fans 123 are connected to the air draining opening 131b.

The air drain duct 131 suctions through the air inlet opening 131a and drains through the draining opening 131b the air blown from the air flow duct 121 by the fans 123 toward the vicinity of the nip portion and releasing recording sheet P from the fixing belt 81. The drained air is suctioned through the air inlet opening 131a of the fans 123 and again blown out from the fans 123 for releasing the sheet.

In FIG. 3, the arrow of solid line b represents the blown air and the arrow of broken line e represents the drained air.

Like this, “the flap” of recording sheet P caused by drained air can be prevented by separating the air drain path from the conveyance path 300 of recording sheet P.

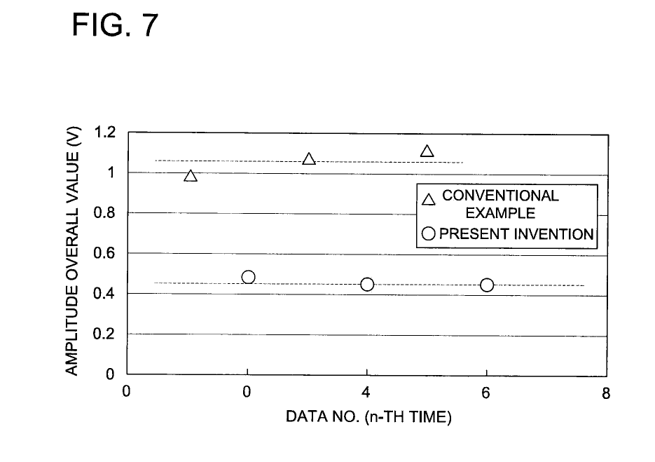

FIG. 7 is a diagram representing results of experiments using the fixing device 8 of the present invention (Embodiment 1) and a conventional fixing device (First comparative sample) which does not separate the air drain path from the conveyance path 300 of recording sheet P.

Recording sheet P is nipped at the nip portion N and is blown the air for releasing by the fans 123, thereby “the flap” is caused and the “flap” is measured by measuring of the amplitude at a fixed position where “the flap” is caused by using a laser displacement meter (LB-01 of KEYENCE corporation). The displacement of recording sheet P, using the measured output (voltage (V)), is frequency-analyzed by a FFT analyzer (CF6400 of ONO SOKKI Co., Ltd.). The vertical axis represents magnitudes of an overall values (V) when the amplitude of the flap of the sheet is frequency-analyzed and represents energy of the amplitude.

By doing this, it is confirmed that the “flap” is reduced to 43% in the fixing device of the present invention in the comparison of overall values, compared to conventional fixing devices and it is effective.

In Embodiment 1, the air inlet opening 131a of drained air has a size of an opening of L=30 mm (refer to FIGS. 4 and 5) and 2 mm in the direction of the height of cross section. The similar effective result can be achieved when the dimension of the air inlet opening 131a is larger than that of the air discharge opening 121a. However if L is too large, recording sheet P is feared to be adhered to the air inlet opening 131a. According to experiments, the phenomenon of the sticking is observed. When L is larger than 75 mm. So L is preferred to be not larger than 75 mm.

The air having passed through the air drain duct 131 is suctioned through the air inlet opening by the fans 123, again blown out by the fans 123, and then blown out through the air blowing duct 121 as air for releasing. Through this way, as air is circulated, it is possible to prevent the temperature of the fixing belt 81 from lowering during a continuous sheet conveyance because warm air can be blown to the fixing belt 81. Therefore it possible to reduce power consumption and aim to realize an energy saving. Further it is possible to prevent air having touched the belt from being scattered inside of the apparatus and to prevent the temperature inside of the apparatus from increasing.

### Embodiment 2

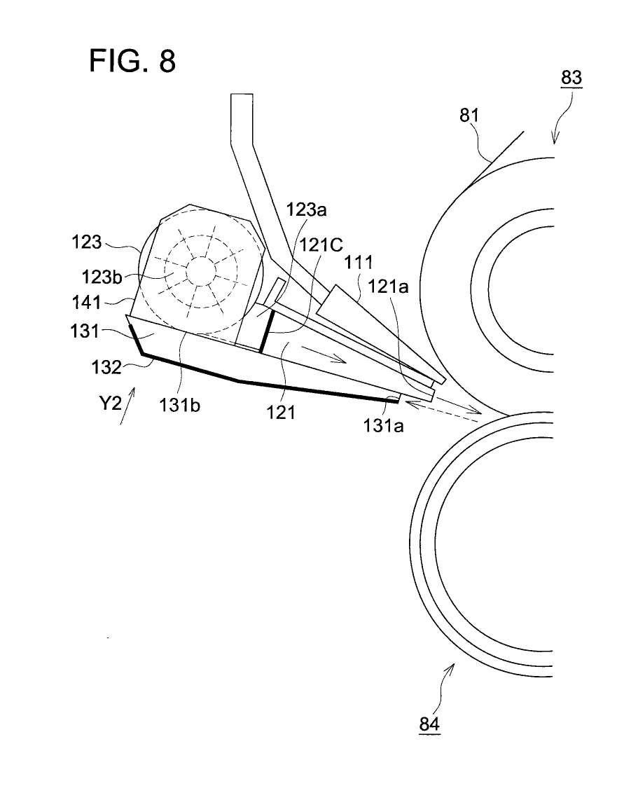

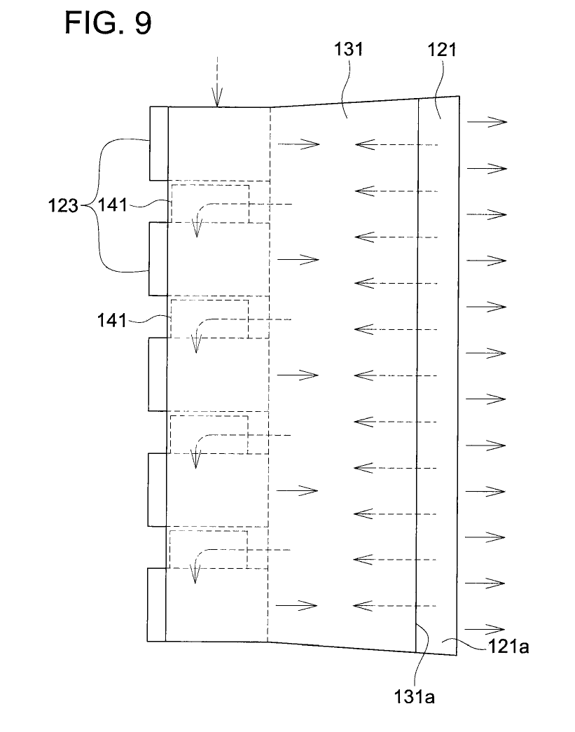

FIG. 8 is a diagram representing Embodiment 2. In FIG. 8, the sheet ejection guide plate 85 and the separation claw 86 are omitted. FIG. 9 is a bottom view viewed in direction of the arrow Y2 of FIG. 8.

In Embodiment 2, compared to Embodiment 1, the fans 123 are disposed such that the air inlet openings 123b face in a perpendicular direction (a direction through front and back of FIG. 8). That is, the direction of the air inlet openings 123b of the fans 123 is provided to be changed 90° compared to Embodiment 1.

The air drain duct 131 and the air inlet openings 123b are connected via a connection duct 141 which connects continuously the air draining opening 131b of the air drain duct 131 and the air inlet openings 123b of the fans 123. However, although, in Embodiment 2, the top most fan 123 on the drawing of FIG. 9 (corresponding to the most front fan 123 of FIG. 8) does not use the connection duct 141 and does not suctions air drained but the air inside of the apparatus, the top most fan 123 may use the connection duct 141 and does not suctions air drained. Other constitutions follow Embodiment 1.

Further the drain duct 131 and the connection duct 141 have openings near the air inlet openings of fans 123, for example, and the fans 123 may be configured to suction the drained air as well as the surrounding air.

In the aforesaid explanation, the blow duct 121 is an integrated type in which five fans 123 are connected with one blow duct 121, however the blow duct 121 may be a separate type in which one fan 123 is connected with one blow duct 121. In the separate type, five blow ducts 121 each of which is provided with an air discharge opening 121a having a width of 60 mm in the width direction of recording sheet P and a height of 1.6 mm in a thickness direction of recording sheet P are arranged continuously in the width direction of recording sheet P.

In the case of Embodiment 2, the number of the fans 123 to be built in can be increased by using fans whose width is thinner than its outer diameter, and the number of the fans can be increased, for example, to five as shown in FIG. 9 and a high flow rate can be obtained. Therefore it is effective for a constitution having a roller of large diameter wherein the releasablility is not high.

### Embodiment 3

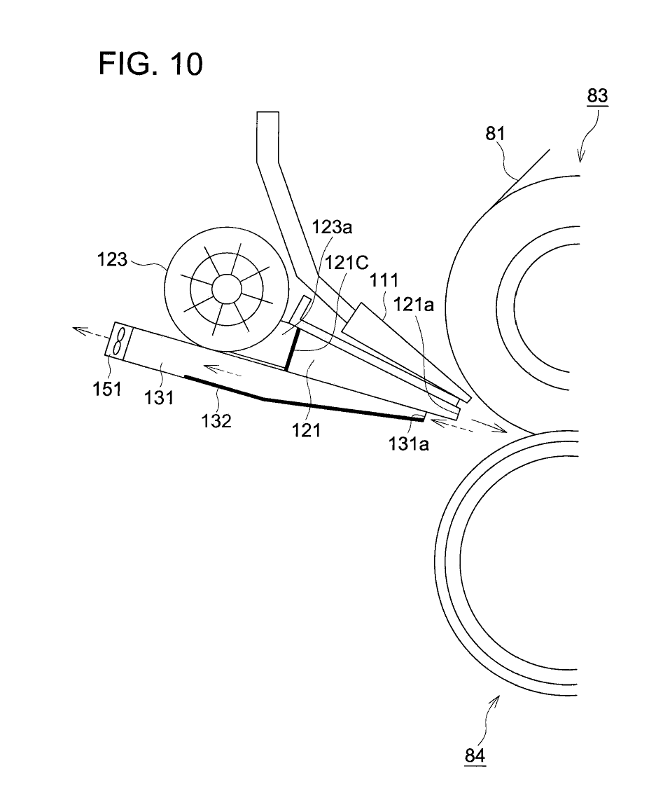

FIG. 10 is a diagram representing Embodiment 3. In FIG. 10, the sheet ejection guide plate 85 and the separation claw 86 are omitted.

In Embodiment 3, the drain duct 131 is provided with a drain fan 151. The drained air flows in the drain duct via the air inlet opening 131a and is drained out to outside by the drain fan 151. The destination of the air draining is preferred to be outside but is not limited to this. In Embodiment 3, the suction air flow rate and the drain air flow rate can be controlled separately and can be optimum individually.

### Embodiment 4

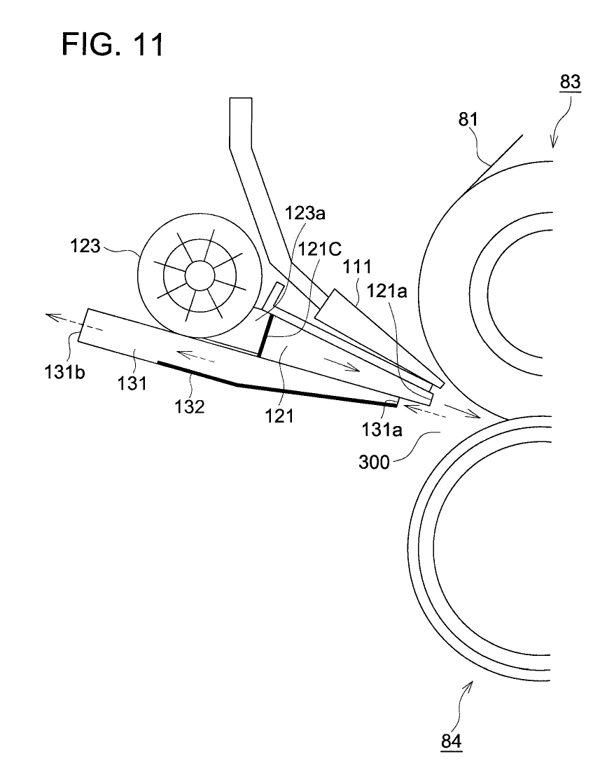

FIG. 11 is a diagram representing Embodiment 4. In FIG. 11, the sheet ejection guide plate 85 and the separation claw 86 are omitted.

Embodiment 4 is an embodiment in which the drain duct 131 is not provided with the drain fan 151 and the air is naturally drained. The drained air flows in the drain duct via the air inlet opening 131a and is drained out to outside from the drain opening 131b. In Embodiment 4, it is not needed to provide the drain fan therefore, a constitution in which the conveyance path 300 of recording sheet P is separated from the drain air path can be achieved with low cost.

The destination of draining air may be outside of the apparatus so that air warmed by the fixing device does not spread inside of the apparatus.

### Embodiment 5

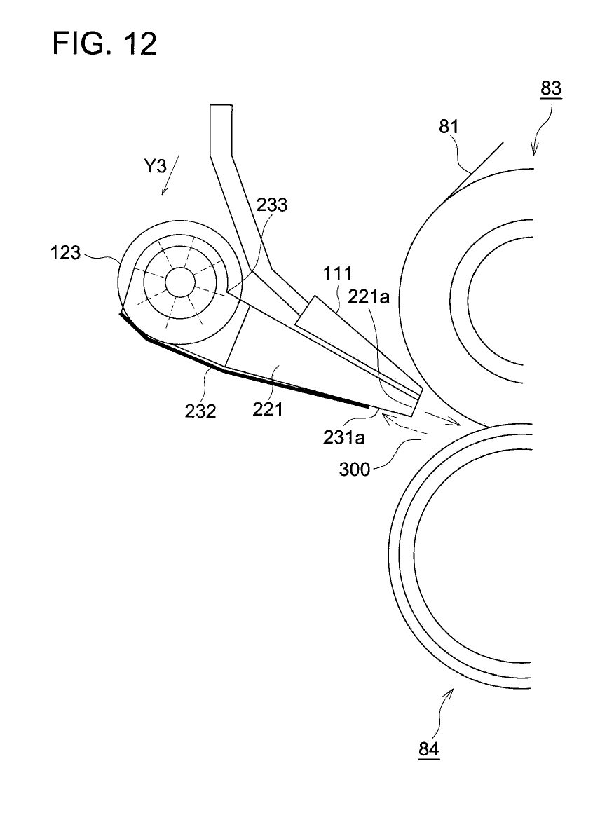

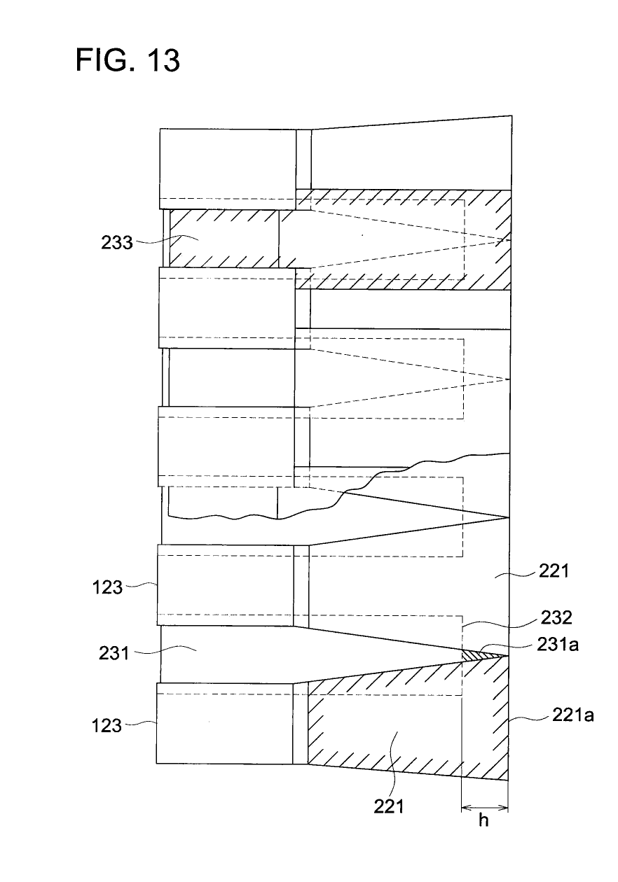

FIG. 12 is a diagram representing Embodiment 5. In FIG. 12, the sheet ejection guide plate 85 and the separation claw 86 are omitted. FIG. 13 is a top view toward the air blow ducts 221 in direction of the arrow Y3 of FIG. 12 and is drawn partially with a broken out section view.

In Embodiment 5 as shown in FIG. 13, five fans 123 and five air blow ducts 221 are provided, and arranged in the width direction of recording sheet P. The air blow ducts 221 spreads in a horn shape toward nip section N in the width direction of recording sheet P. Therefore the air discharge opening 221a of 60 mm in the width direction of recording sheet P and 1.6 mm in the sheet thickness direction are continuously arranged in the width direction of recording sheet P

With this configuration, as shown in FIG. 13, a space of triangle shape at the edge surrounded by fans 123 and air blow ducts 221 is formed.

In the embodiment 5, this space is used as an air drain path, that is, as air drain duct 231. With this configuration, drain paths are arranged periodically.

A separation plate 232 which separates the air drain path and the conveyance path is provided at the lower side (side to the conveyance path 300) of the drain duct 231. The separation plate 232 is a member constituting a part of the drain duct 231. The separation plate 232 is provided so as to open a part of the triangle shape section of this space in the direction toward the nip portion N. The opening is an air suction opening 231a of the drain air.

A duct upper plate 233 is provided at the upper side of this space is provided built so as to close the upper side of this space and the air inlet openings of the fans 123 are built so as to connect this space.

As explained above, the drain duct 231 is configured to connect continuously the air inlet opening and fans 123.

A duct upper plate 233 may not be a shape to close the upper side of the space but, for example, a shape provided with a opening near the air inlet opening of the fans 123 so that fans suction not only drain air but also surrounding air.

In Embodiment 5, the air blow ducts 221 and the drain ducts 23 lean be provided with a same height in the cross section direction, therefore it is possible to constitute the air blow ducts 221 and the drain ducts 231 compact and the air blow ducts 221 and the drain ducts 231 can be provided at the vicinity of the outlet of the nip portion N. This is further effective in the case when the diameter of the roller is large and the releasablility is not good.

The dimension of the air suction opening 231a is needed to be larger than the dimension of an air blow out opening 221a and, in this embodiment, a height of triangle is larger than 26 mm (h of FIG. 13).

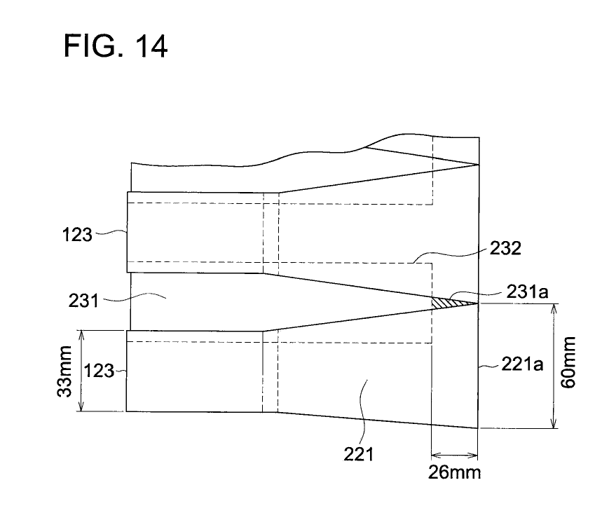

FIG. 14 is a diagram representing an approximate size of Embodiment 5.

Further a openable and closable shielding member (not shown in the drawing) is disposed at the air suction opening 231a. The air suction opening 231a to suction drained air is closed when a small size sheet is conveyed and drained air is not blown but surrounding air with low temperature is blown to the fixing belt to prevent from the temperature of the edges from going up.

### Embodiment 6

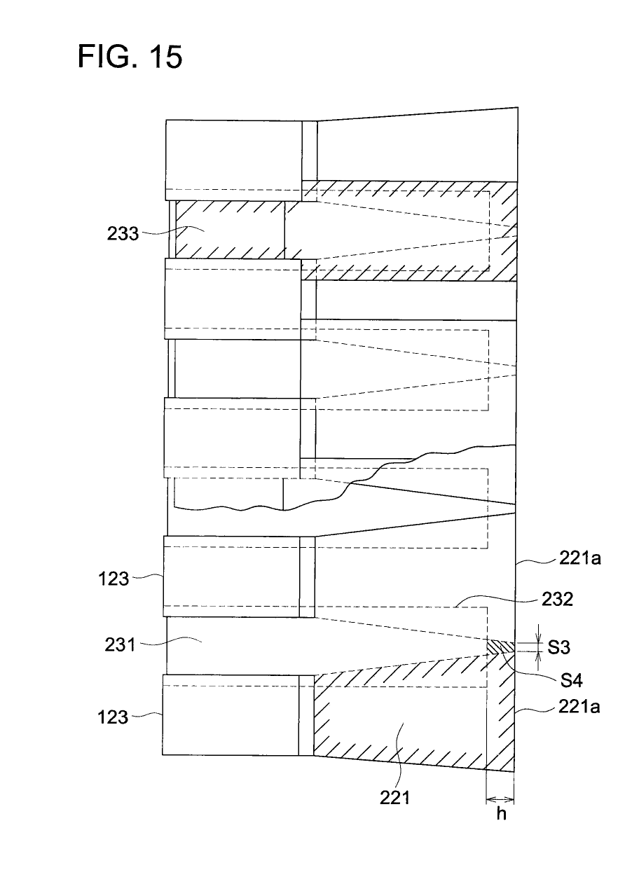

FIG. 15 is a diagram representing Embodiment 6. FIG. 15 is a top view toward the air blow ducts 221 in the same direction as FIG. 13 and is drawn partially with a broken out section view.

In the embodiment 6, compared to FIG. 5, air drain duct 221s are arranged periodically.

The sizes in the width direction of the recording sheet P of air discharge opening 221a of the air blow ducts 221 are formed small and the air blow ducts 221, that is, the air discharge opening 221a are arranged periodically so as to form gaps S3. With this configuration, the gaps between the air discharge opening 221a also can be used as air discharge opening 221a of air and the air suction opening 231a can be arranged with approaching nearer to the nip portion N. The configuration can be effective to the flap because the air drain path and the conveyance path 300 can be separated at a nearer position to the nip portion.

The air suction opening 231a formed of the gaps S3 and the gaps S4 of trapezoids at the bottom surface. Therefore the height of the height of the trapezoids S4 (h of FIG. 15) can be lower than the height of the triangle (h of FIG. 13). In the Embodiment 6, the gaps S3=7 mm and h of the trapezoids S4=121 nm. Other configurations follow to Embodiment 5.

### Embodiment 7

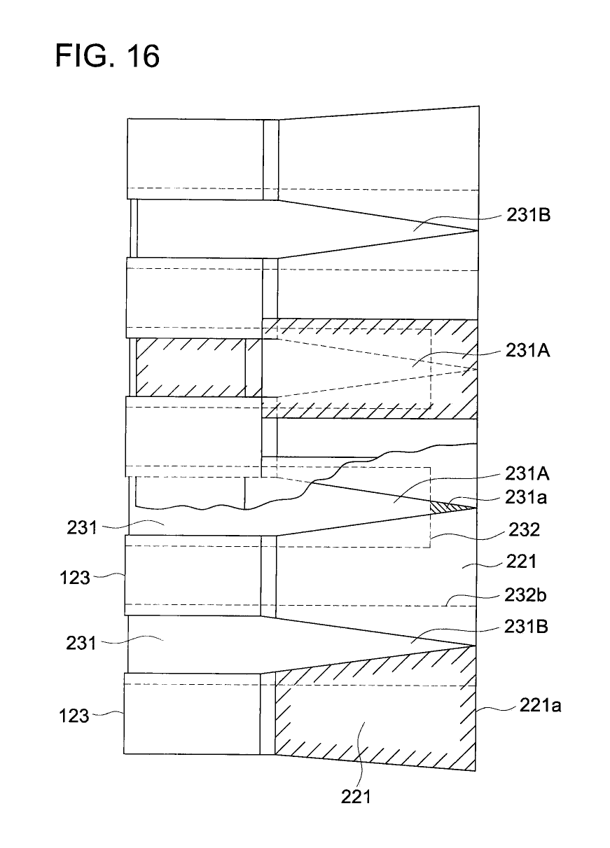

FIG. 16 is a diagram representing Embodiment 7. FIG. 16 is a top view toward the air blow ducts 221 in the same direction as FIG. 13 and is drawn partially with a broken out section view.

In Embodiment 7, compared to Embodiment 5, air drain paths are not arranged at the both sides because, air tends to flow out toward the nip portion N at the both ends.

Similar to Embodiment 5, in the Embodiment 7, spaces at both sides of fans 123 and the air blow ducts 221 are not used as air drain paths. That is, among spaces 231A and 231B in FIG. 16, drain paths are not forms at spaces at both sides but formed at spaces 231A. Therefore, similar to Embodiment 5, drain duct 231 is formed at spaces 231A.

Separation plates 232b at the bottom surface side of spaces 231B are configured to close the bottom surfaces. Other configurations follow Embodiment 5.

With Embodiment 7, the constitution can be simple, and the cost of the apparatus can be reduced.

### Embodiment 8

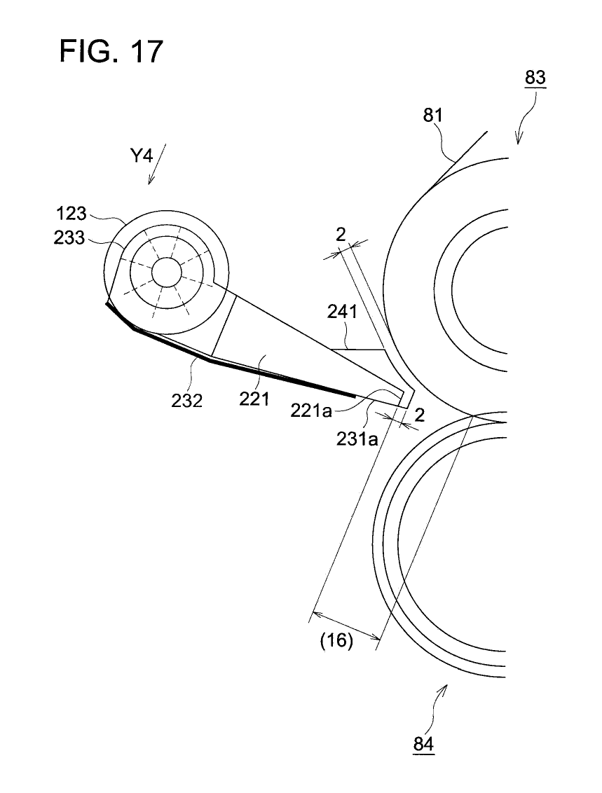

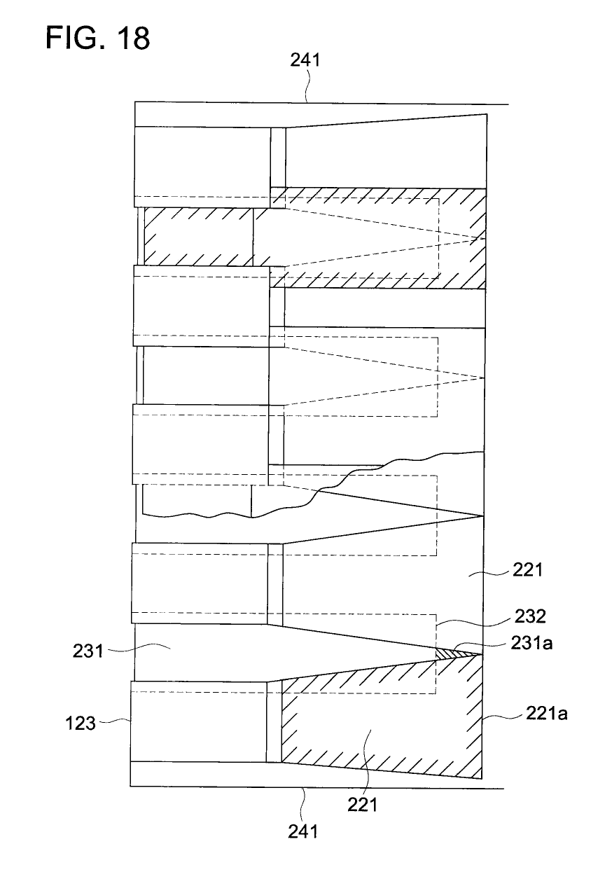

FIG. 17 is a diagram representing Embodiment 8. Air nozzles 111 are omitted. FIG. 18 is a top view toward the air blow ducts 221 in direction of the arrow Y4 of FIG. 17 and is drawn partially with a broken out section view

In Embodiment 8, edge section shield plates 241 (air drain side wall member) are provides at both side surfaces of drain ducts 231 of Embodiment 5. The edge section shield plates 241 extend from the air discharge opening 221a in a direction toward the nip portion N and toward the fixing belt 81. The jetted air is prevented from leaking to the both sides without being blown to the nip portion N and the air rates of fans 123 at both sides can be reduced through the extending of the edge section shield plates 241 as shown is FIG. 17.

In the embodiment, as shown in FIG. 17, gaps between the edge section shield plates 241 and the fixing belt 81 is 2 mm, the length of the extending of the edge section shield plates 241 from the air discharge opening 221a is 2 mm.

The edge section shield plates 241 can be applied to other embodiments.

### Embodiment 9

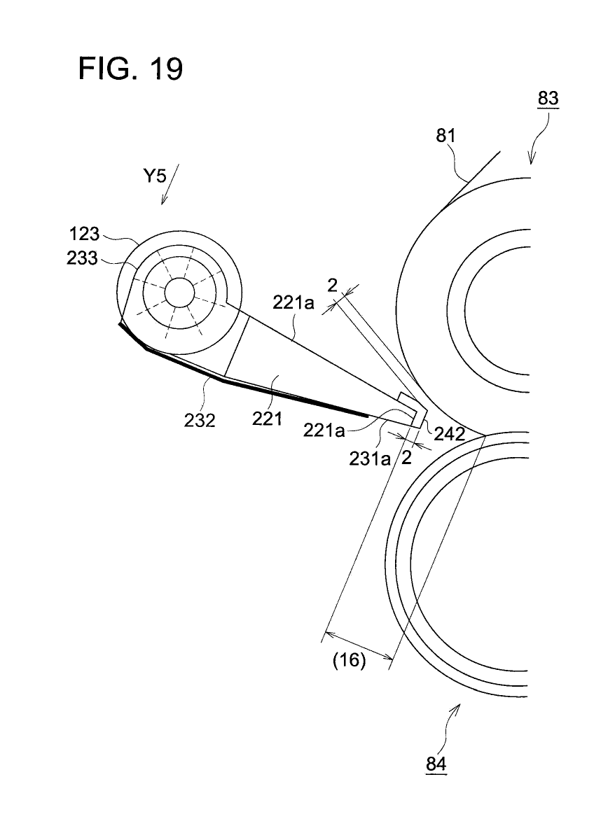

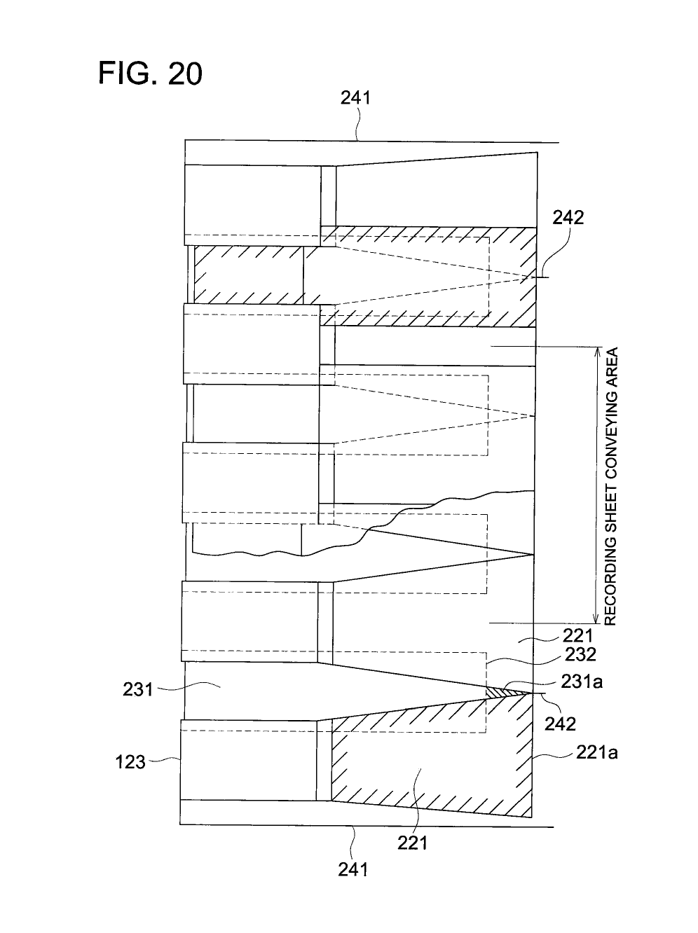

FIG. 17 is a diagram representing Embodiment 9. FIG. 20 is a top view toward the air blow ducts 221 in direction of the arrow Y4 of FIG. 19 and is drawn partially with a broken out section view.

In Embodiment 9, middle shield plates 242 (middle side wall members) are added to embodiment 8 and the edge section shield plates 241 are omitted.

The middle shield plates 242 are provided at boundary positions of the air blow ducts 221 of both sides corresponding to size widths of small standard size sheet and extend from the air discharge opening 221a in a direction toward the nip portion N and toward the fixing belt 81.

The middle shield plates 242 extending very neat to the nip portion N can prevent the jetted air to each size of sheets from leaking better than Embodiment 8 and blow air effectively.

Further at this time, fans 123 at the both sides may be stopped. In case when the fans 123 at the both sides are stopped, although jetted air from fans at most outer sides in operation tends to go away to both side edges of the fixing belt 81, no problems occur because of the middle shield plates 242 even if the fans 123 at the both sides are stopped.

The middle shield plates 242 may be provided respectively for various sizes of sheet and may be moved by a unit of the air blow duct 221 corresponding to sheet sizes. The movement of the middle shield plates 242 may be performed manually and may be automatically.

In the present embodiment, as shown in FIG. 19, gaps between the middle shield plates 242 and the fixing belt 81 is 2 mm, the length of the extending of middle shield plates 242 from the air discharge opening 221a is 2 mm.

The middle shield plates 242 can be applied to other embodiment of the separate type wherein one fan 123 is connected to on air flow duct 121.

### Embodiment 10

The Embodiments through 1 to 9 are constructions wherein fans and a compressor are used in combination, however when the releasability is high, a construction of only fans 123 without using a compressor, that is, without using nozzles 111, also can be configured for the Embodiments through 1 to 9. With this construction, a size reduction and a cost reduction can be aimed.

According to the Embodiments, flaps of recording sheet P caused by drain air can be prevented and stable sheet conveyances can be performed, by separating the sheet conveyance path and the drain path of air by using the separation members.

What is claimed is:

1. A fixing device fixing a toner image onto a recording sheet carrying the toner image thereon by applying a pressure and a heat during conveying the recording sheet in a nip portion, comprising:
a fixing member including a heating section;
a pressure-applying member, by pressing the fixing member, forming the nip portion which sandwiches the sheet carrying the toner image;
an air blow duct provided with an air discharge opening which opens toward a vicinity of an outlet of the recording sheet of the nip portion; and
an air blowing section which blows air toward the vicinity of the outlet of the recording sheet through the air blow duct,
wherein fixing device further comprises an air drain path provided with an air suction opening at the vicinity of the outlet of the recording sheet and suctioning the air blown toward the vicinity of the outlet of the recording sheet from the air suction opening thereby draining the air, the air drain path separated from a sheet conveyance path by a separation wall member and formed above the sheet conveyance path.

2. The fixing device of claim 1, wherein the air suction opening is provided in a continuous manner in a longitudinal direction of the nip portion which is perpendicular to a conveyance direction of the recording sheet.

3. The fixing device of claim 1, wherein the air suction opening is provided in a periodical manner in a longitudinal direction of the nip portion which is perpendicular to a conveyance direction of the recording sheet.

4. The fixing device of claim 1, wherein the air drain path is formed of an air drain duct provided with the air suction opening and an air draining opening and wherein the separation wall member constitutes a part of the air drain duct.

5. The fixing device of claim 4, wherein the air draining opening is connected to an air inlet opening of the air blowing section.

6. The fixing device of claim 1, wherein the air blowing section is a centrifugal fan wherein a direction of inletting air and a direction of blowing air are perpendicular.

7. The fixing device of claim 4, further comprising an air drain section, wherein an air inlet opening of the air drain section communicates with the air drain opening.

8. The fixing device of claim 1, wherein the air drain path is arranged at least at a center part in a longitudinal direction of the nip portion.

9. The fixing device of claim 1, wherein a dimension of the air suction opening of the air drain path is larger than that of the air discharge opening of the air blow duct.

10. The fixing device of claim 1, wherein air drain side wall members are provided at both side surfaces of the drain path in a longitudinal direction of the nip portion and parts of the air drain side wall members extend nearer to the vicinity of the nip portion N than the air discharge opening and the air inlet opening.

11. The fixing device of claim 10, wherein middle side wall members parallel to the drain side wall members are provided at a position corresponding to a size of a width of a standard size recording sheet and extend nearer to the vicinity of the nip portion N than the air discharge opening and the air inlet opening.

12. The fixing device of claim 1, wherein the blowing section includes a fan and a compressor, so as to blow air continuously toward the vicinity until a moment when the whole of the recording sheet has been passed through the nip portion in such a manner as to blow air with a higher air speed toward the vicinity when a leading edge of the recording sheet comes out from the outlet than after the leading edge protrudes more than a predetermined length from the outlet of the recording sheet.

13. An image forming apparatus comprising the fixing device of claim 1.
